(19) United States
(12) Patent Application Publication
(10) Pub. No.: US 2006/0032985 A1
(43) Pub. Date: Feb. 16, 2006

(54) Clutch driven reaction wheel steering unit

(76) Inventors: Monty Smith, Eddy, TX (US); Jeffery E. Maestas, Benbrook, TX (US)

Correspondence Address: Michael G. Cameron, Suite 600, 2435 N. Central Expressway, Richardson, TX, 75080, US

(21) Appl. No.: 11/099,379

(22) Filed: Apr. 5, 2005

Related U.S. Application Data
(60) Provisional application No. 60/559,893, filed on Apr. 6, 2004.

(51) Int. Cl. B64G 1/28

(52) U.S. Cl. 244/165

(57) ABSTRACT

What is disclosed is a clutch driven reaction wheel steering unit having at least a single drive motor (101) coupled indirectly to a plurality of flywheels operable to provide momentum for all three axes in a single unit. In an exemplary embodiment, the drive motor (101) is mounted within a unit frame (203). A plurality of gears, including miter gears, are coupled directly or indirectly to the drive motor (101). Six flywheels (102A, 102B, 102C, 102D, 102E and 102F) are coupled to the ends of a plurality of shafts which extend through or are supported by the unit frame (203). Clutches are operable to selectively transmit rotational motion to the second plurality of shafts.

### CLAIM OF PRIORITY

This application claims priority to U.S. Provisional Patent Application Ser. No. 60/559,893, filed Apr. 6, 2004, entitled “Clutch Driven Reaction Wheel Steering Unit,” the entire contents of which are incorporated herein by this reference

### STATEMENT REGARDING FEDERALLY SPONSORED RESEARCH OR DEVELOPMENT

No federal grants or funds were used in the development of the present invention.

### FIELD OF THE INVENTION

The present invention relates to a system for vehicle stabilization and attitude control and, more particularly, to a flywheel based system for these purposes.

### BACKGROUND OF THE INVENTION

The ability to stabilize a vehicle, particularly spacecraft in orbit and to reposition it as necessary is of great importance. Without this capability, most satellites and missile systems would not function properly. There have been a variety of systems developed to provide vehicle attitude control, with the majority using some form of gyroscopic device. An early approach was to use a series of stationary mounted gyroscopes each mounted to the vehicle in such manner that the individual torques produced was orthogonal to one another. These gyroscopic devices, commonly known as Reaction Wheel Assemblies (“RWA”) or Momentum Wheel Assemblies (“MWA”), are commercially available from a variety of sources. Such assemblies are described in Honeywell's brochure entitled “Reaction Wheel and Momentum Wheel Assemblies,” April 1993. In operation, the stationary RWA/MWA units generally rotate at a near constant speed. A determination that the vehicle is to be repositioned can be made internally by a vehicle's on board computer system or by a ground based controller. Systems on board the vehicle determine the direction and magnitude of movement as well as the amount of torque each of the units will have to accomplish the repositioning. Torque is generated by the RWA/MWA units by either speeding up or slowing down a flywheel spinning within the unit, resulting in a change in momentum. This change in momentum generates the torque provided to the vehicle, causing it to move in the desired direction. RWA/MWA units provide a reliable, cost effective way to generate vehicle torques. However, RWA/MWA units are only able to produce low levels of torque output, on the order of 1.6 Newton-meters (“N-m”) or less.

As a result of this shortcoming, systems have been developed to increase the torque output. One such system known as a Momentum Wheel Platform (“MWP”) is described in U.S. Pat. No. 5,112,012 to Yuan et al. The MWP consists of an RWA/MWA unit mounted to a triangular shaped plate. Mounted to the corner of the plate are a series of jack screw legs which are controlled by independently operated stepper motors. The screws move up and down, causing the platform to tilt. The tilting of the platform, coupled with the torque generated by the RWA/MWA unit, results in an increased torque output. However, the jack screws cannot move fast enough or far enough to produce the desired high torque levels for the time durations necessary in certain spacecraft designs.

To produce high levels of torque output, on the order of 305 N-m or more, for large, rapidly positioned spacecraft, a system know as a Control Moment Gyroscope (“CMG”) was developed. This type of system is commercially available from a variety of sources and is described in Honeywell's brochure entitled “Control Moment Gyroscopes,” April 1993. The control moment gyroscope consists of a spherical shell rotor spun at 5,000 to 6,000 rpm. The shell rotor is mounted within a single or multi-axis gimbal. Torque is generated by rotating the spinning shell rotor about one or more of the gimbals' axes. The system can produce high levels of torque output, and is capable of being rotated a full 360 degrees. However, these devices are large, approximately a meter in diameter, heavy, weighing 53 kilograms or more, and costly. Due to its complexity, the CMG is not as reliable as other torque producing systems and it has a high minimum weight, which prevents it from being effectively scaled down.

### SUMMARY OF THE INVENTION

The objective of the present invention is to address the shortcomings of conventional designs. Most of the existing designs rely on a series of stepper motors or jack screws to affect desired changes in momentum. Current mechanisms use motor speed to vary momentum, or a jack screw to change the axis of rotation to affect the momentum of the attached flywheel. As a result, these designs have limited bandwidth and limited capability. The present invention uses a single drive motor providing momentum for all three axes in a single unit. The use of a single motor reduces device complexity and simplifies device control. In addition, most conventional designs require a separate mechanism for each axis that is to be controlled. The present invention is adapted to control all three axes of rotation in a single unit.

An exemplary embodiment of the present invention uses a series of six (6) clutches that can be engaged to affect the momentum of the device in all axes of rotation resulting in almost infinite maneuverability. In addition, because the speed of the motor remains substantially constant, the resulting bandwidth of the device is also substantially infinite. The present invention exchanges the momentum for device rotation from the kinetic energy of the spinning flywheels on its three axes. This exchange of momentum results in the conversion of kinetic energy to rotational momentum yielding near infinite bandwidth vehicle maneuverability.

In an exemplary embodiment of the present invention, the flywheels are constructed of low mass materials including high strength composite materials that allow for extremely high rotational speeds. High rotational speeds can then be translated into high rotational torque essential for a vehicular steering mechanism. High strength composite flywheels are conventionally available from manufacturers for high spin rate energy storage devices.

This present invention overcomes many of the obstacles presented by conventional designs. It is not bandwidth limited; it is scalable; it requires only one drive motor; and a single device controls all rotational axes.

### BRIEF DESCRIPTION OF THE DRAWINGS

FIG. 1 is an isometric view of the present invention;

FIG. 2 is an isometric view of the present invention with flywheels removed;

FIG. 3 is a section view showing specific components; and

FIG. 4 is an additional view perpendicular to the view seen in FIG. 3.

### DETAILED DESCRIPTION OF AN EXEMPLARY EMBODIMENT

While an exemplary embodiment of the present invention is discussed in detail below, it should be appreciated that the present invention provides many applicable inventive concepts which can be embodied in a wide variety of specific contexts

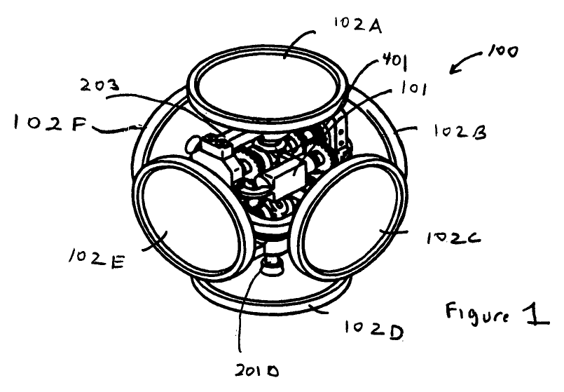

FIG. 1 provides an isometric view of the present invention showing assembly 100 including drive motor 101. Also seen are six flywheels 102A, 102B, 102C, 102D, 102E and 102F, operable to turn the unit through all three axes of rotation. More generally, the clutch driven reaction wheel steering unit comprises a unit frame 203, the drive motor 101 being mounted within or supported by the unit frame 203. A motor unit shaft extends out from the drive motor 101. A motor unit gear is coupled to an end of the extended drive motor shaft. A plurality of gears, including miter gears, are coupled directly or indirectly to the drive motor gear. A first plurality of shafts are coupled to the plurality of gears and mounted within and through, or supported by, the unit frame 203. A plurality of flywheels are coupled to the ends of a second plurality of shafts which extend through, or are supported by, the unit frame 203. Clutches are operable to selectively transmit rotational motion to the second plurality of shafts.

FIG. 2 is an isometric view of the present invention with flywheels removed. As seen therein, drive motor 101 is coupled to the six flywheels 102A, 102B, 102C, 102D, 102E and 102F via the first plurality of shafts and second plurality of shafts 201A, 202B, 202C, 202D, 202E and 202F through the plurality of gears 202, including miter gears 401. Unit frame 203 provides a frame to rigidly hold the drive motor 101, and shafts in place. The plurality of gears 202 and miter gears 401 transmit mechanical power and motion from drive motor 101 via a first plurality and second plurality of shafts to the six flywheels 102A, 102B, 102C, 102D, 102E and 102F.

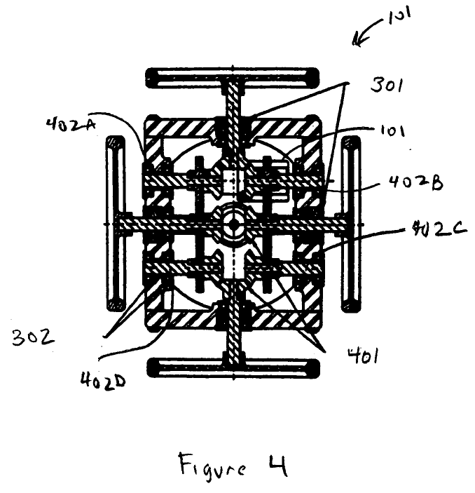

The three axis of rotation, x, y, and z are defined, for example, by shafts 201A and 201D (x); 201B and 201E (y); and 201C and 201F (z). Momentum in the system is changed when a clutch on second plurality of shafts 201A, 202B, 202C, 202D, 202E and 202F, or axis (x), (y), or (z) engages or disengages said second plurality of shafts from the first plurality of shafts 402A, 402B, 402C and 402D (as seen in FIG. 4). The result is a change in momentum about that axis. This change in momentum produces the necessary torque required to rotate the device about that axis. Due to this design, the resultant torque produced is limited only by the size of the flywheels and their rotational spin rate. Through the use of low mass and high strength materials, extremely high spin rates can be achieved. These high spin rates translate to high rotational torque resulting in extreme maneuverability.

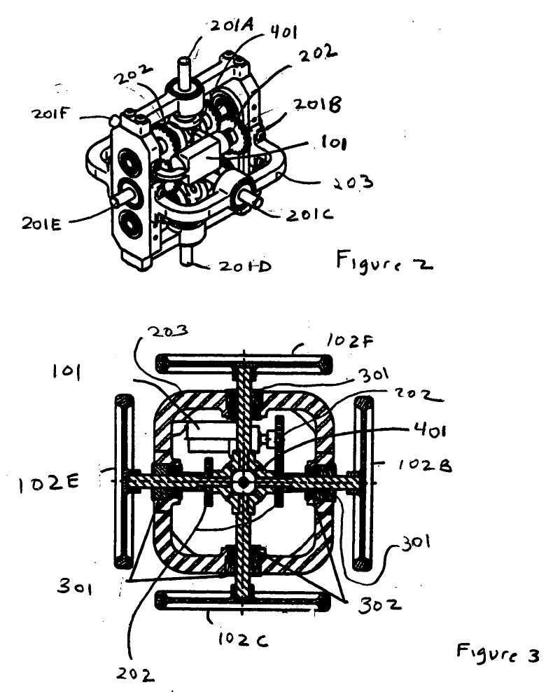

Referring now to FIG. 3, specific components can be seen from a top view. As seen therein, clutches 301 on shafts 202B, 202C, 202E and 202F (clutches for shafts 202A and 202D are not show due to the view provided) are operable, when disengaged, to reduce the rotation of corresponding flywheels 102B, 102C, 102E and 102F. Bearings and related mechanisms 302 are operable to decrease friction between the housing unit 203 and the shafts 202A, 202B, 202C, 202D, 202E and 202F.

FIG. 4 is an additional view perpendicular to the view seen in FIG. 3, showing clutches 301, bearings 302 and miter gears 401. Miter gears transmit power and motion between nonparallel axes. Miter gears 401 preferably are made for a 1:1 ratio at 90°.

A variety of materials can be used for the construction for the components of the invention, including metals or plastics. For example, the gears are made from a wide variety of materials with many different properties. Factors such as design life, power transmission requirements, noise and heat generation, and presence of corrosive elements contribute to optimization of gear material. Metal choices include, among other things, aluminum, brass, bronze, cast iron, steel, hardened steel, and stainless steel. Plastic materials may include acetal, Delrin, nylon, and polycarbonate.

Depending on the location and purpose of the specific gear within the unit, the gear may be mounted on a hub or shaft. A hub is a cylindrical projection on one or both sides of gear, often for the provision of a screw or other shaft attachment mechanism. Hubless gears are typically attached via press fit, adhesive, or internal keyway. Shaft mounting choices include keyway, set screws, hub claming screws, split, and simple bore. Likewise, the flywheels 102A, 102B, 102C, 102D, 102E and 102F, may be mounted to the shaft using a keyway, set screws, hub claming screws, split, or simple bore.

The present invention can be scaled up or down depending on the torque required and the vehicle to be steered. Because of this scalability, the device can be used on a variety of devices and vehicles other than spacecraft that require rapid, precise steering. In addition, nanotechnology can be employed in the development and design of this device to be used in nano-scale applications.

The embodiment shown and described above is only exemplary. Even though several characteristics and advantages of the present invention have been set forth in the foregoing description together with details of the invention, the disclosure is illustrative only and changes may be made within the principles of the invention to the full extent indicated by the broad general meaning of the terms used in herein and in the attached claim.

What is claimed is:

1. A clutch driven reaction wheel steering unit, comprising:
a unit frame;
at least one drive motor mounted within the unit frame;
a rotatable drive motor shaft extending from the at least one drive motor;
a drive motor gear coupled to an end of the drive motor shaft;
a plurality of gears coupled directly or indirectly to the drive motor gear;
a first plurality of shafts coupled to the plurality of gears and rotatably mounted to, through or supported by the unit frame;
a second plurality of shafts; and
a plurality of flywheels coupled to the ends of the second plurality of shafts.

2. The unit of claim 1, further comprising a plurality clutches in communication with the second plurality of shafts, operable to selectively control the speed of second shafts and hence the flywheels.

3. The unit of claim 2, wherein the second plurality of shafts comprise six shafts, and wherein the plurality of flywheels comprise six flywheels; and
said six shafts coupled to the at least one drive motor unit via the first plurality of shafts and plurality of gears.

4. The unit of claim 3, wherein the unit is adapted to exchange momentum for device rotation when the velocity of the of at least one flywheel on an axis of rotation is modified.

5. The unit of claim 3 wherein each of the six shafts and six flywheels are adapted to operate in sets of three, corresponding to the x, y and z axis of rotation.

6. The unit of claim 2, wherein the unit frame is mounted on a gimbal mechanism.

7. The unit of claim 6, wherein the unit frame is mounted on a single-axis gimbal.

8. The unit of claim 6, wherein the unit frame is mounted on a multi-axis gimbal.

9. The unit of claim 2, wherein the speed of the at least one motor drive remains substantially constant during operation.

10. The unit of claim 2, wherein the plurality of flywheels are made of a low mass and high strength material.

11. The unit of claim 10, wherein the flywheels are made of one from the group consisting of metal and plastic.

12. The unit of claim 2, for use in a vehicle.

13. The unit of claim 12, wherein the vehicle is a spacecraft.

14. The unit of claim 12, wherein the unit is a missile.

15. A device for controlling rotations of a vehicle, comprising:
a frame unit;
a drive motor within the frame unit;
a plurality of interconnected shafts and gears; and
six flywheels having an orthogonal arrangement in three dimensions.

16. The device of claim 15, further comprising having a mechanism to slow at least one flywheel so as to provide a net torque.

17. The device of claim 16, wherein the device is operable to turn the device through all three axes of rotation.

18. The unit of claim 17, wherein the vehicle is a spacecraft.

19. The unit of claim 17, wherein the unit is a missile.

20. A method for providing a torque, comprising:
coupling six flywheels to a source of rotational motion within a frame;
spinning the six flywheels at a substantially constant speed; and
slowing at least one of the flywheels to provide a net torque.
